(19) United States
(12) Patent Application Publication
(10) Pub. No.: US 2002/0113996 A1
(43) Pub. Date: Aug. 22, 2002

(54) Data supplier, printer and print system

(75) Inventor: Jun Minakuti, Osaka (JP)

Correspondence Address: MCDERMOTT, WILL & EMERY, 600 13th Street, N.W., Washington, DC, 20005-3096, US

(73) Assignee: Minolta Co., Ltd.

(21) Appl. No.: 10/066,559

(22) Filed: Feb. 6, 2002

(30) Foreign Application Priority Data
Feb. 16, 2001 (JP) 2001-40270

(51) Int. Cl. G06F 15/00

(52) U.S. Cl. 358/1.15

(57) ABSTRACT

A print system in which a digital camera 1 is detached from a printer 3 based on the ending of a lock state via user operation of an unlock button 17 includes a lock controller 201 that determines whether or not the digital camera 1 and the printer 3 are communicating with each other. When they are not communicating, the lock state is ended by a plunger 253 pulling the lock member 251 that maintains the connection between the two apparatuses in a lock state. When they are communicating, the user operation of the unlock button 17 is deemed invalid. Consequently, printing errors that are caused by erroneous detachment of the digital camera 1 from the printer 3 while they are communicating with regard to printing are prevented.

This application is based on application No. 2001-40270 filed in Japan, the content of which is hereby incorporated by reference.

### BACKGROUND OF THE INVENTION

1. Field of the Invention

This invention relates to a technology by which to perform printing while connecting the printer to a data supplier that sends print data.

2. Description of the Related Art

Small-sized portable printers and built-in printers have been conventionally provided in order to satisfy users' desire to print and view immediately images captured using a digital camera. However, such a solution has entailed the problems that (1) a cable by which to connect the portable printer to the digital camera must also be included, and (2) in the case of a built-in printer, the overall size of the digital camera increases as a result, or only small-sized paper can be used. Therefore, in order to resolve these problems, digital cameras that can be integrated with a printer through an easy operation have been proposed.

However, because such a digital camera can also be detached from the printer through an easy operation as well, the problem exists that printing fails if the user mistakenly performs the operation to separate the two apparatuses while data is being sent from the digital camera to the printer.

### SUMMARY OF THE INVENTION

In view of the problems identified above, an object of the present invention is to reduce printing errors caused by erroneous user operation.

The first aspect of the present invention comprises a data supplier that transmits print data, wherein such supplier includes a connector that can be connected to a printer, a transmitter that sends print data to the printer via the connector, a lock mechanism that physically locks the connection established using the connector, and a lock controller that maintains the lock secured by the lock mechanism at least while communication regarding printing is being carried out with the printer.

Another aspect of the present invention comprises a printer including a connector that can connected to a data supplier that sends print data, a printing portion that performs printing based on print data sent from the data supplier via the connector, a lock mechanism that physically locks the connection established using the connector, and a lock controller that maintains the lock secured by the lock mechanism at least while communication regarding printing is being carried out with the data supplier.

Still another aspect of the present invention comprises a print system including a printing portion that performs printing based on print data, a transmitter that can be connected to or separated from the printing portion and that sends print data to the printing portion while being connected thereto, a lock mechanism that physically locks the connection established between the printing portion and the transmitter, and a lock controller that maintains the lock secured by the lock mechanism at least while communication regarding printing is being carried out between the printing portion and the transmitter.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 shows a first embodiment of the present invention and comprises a front elevation of a print system incorporating a digital camera and a printer;

FIG. 2 is a rear elevation of the digital camera and printer shown in FIG. 1;

FIG. 3 is a block diagram showing the construction of the digital camera of the first embodiment;

FIG. 4 is a vertical cross-sectional view showing the internal construction of the printer;

FIG. 5 is a drawing showing the connectors of the digital camera and the printer of the first embodiment;

FIG. 6 is a flow chart by which to explain the unlock operation in the digital camera;

FIG. 7 shows a second embodiment of the present invention and comprises a block diagram showing the construction of the printer;

FIG. 8 is a drawing showing the connectors of the digital camera and the printer in the second embodiment;

FIG. 9 is a drawing showing a modified example of the print system;

FIG. 10 is a drawing showing a computer and a printer in a connected state; and

FIG. 11 is a drawing showing another modified example of the print system.

### DETAILED DESCRIPTION OF THE PREFERRED EMBODIMENTS

<1. First Embodiment>

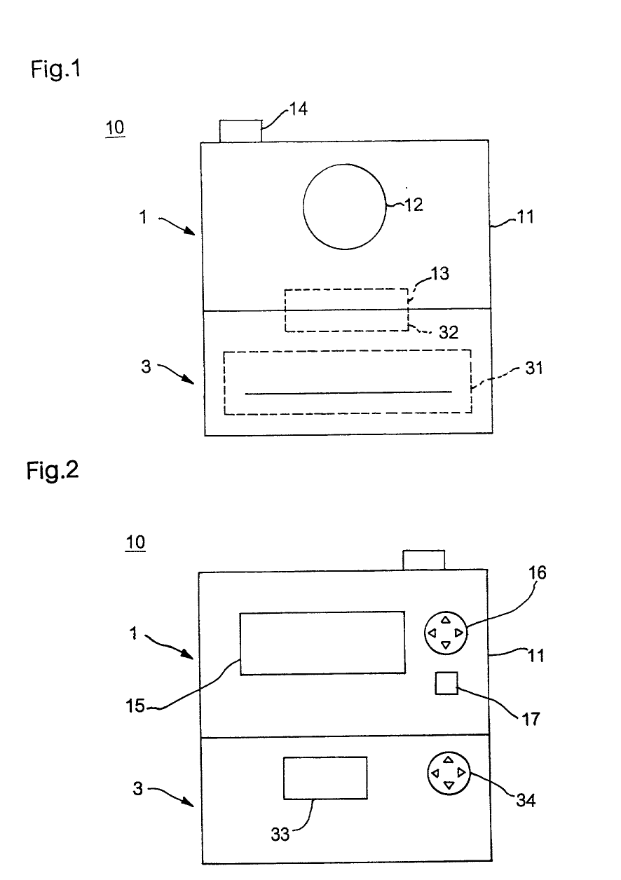

FIG. 1 is a front elevation showing a print system 10 incorporating a digital camera 1 and a printer 3 connected thereto. The digital camera 1 functions not only to capture images but also functions as a data supplier that sends print data to the printer 3.

The digital camera 1 has an optical system 12 on the front surface of the main body 11, and also has at the bottom of the main body 11 a connector 13 that connects the main body 11 and the printer 3. On the top surface of the main body 11 is located a shutter start button (hereinafter ‘start button’) 14 that receives from the user a command to begin image capture. The image obtained as digital data via the optical system 12 is processed by the main body 11 where appropriate, and is then stored.

The printer 3 has in the interior thereof a printing portion 31 that performs printing, and a connector 32 on the top surface that can be connected with the connector 13 of the digital camera 1. Print data that includes image data can be transferred from the digital camera 1 via the connectors 13 and 32. The configurations of the connectors 13 and 32 are described in detail below.

FIG. 2 is a drawing showing the digital camera 1 and the printer 3 seen from the rear. A liquid crystal display 15 that displays the captured image or user menus is located in the center of the rear surface of the main body 11, and an operation button 16 by which to carry out input operations in accordance with the menu displayed on the display 15 is located to one side of the display 15. An unlock button 17 is located below the operation button 16. As described below, the connection between the digital camera 1 and the printer 3 can be physically locked, and the unlock button 17 is used to instruct that the lock state be terminated.

On the rear surface of the printer 3 are located a liquid crystal display 33 that displays user menus, as well as an operation button 34 by which to perform input operations regarding the printer 3.

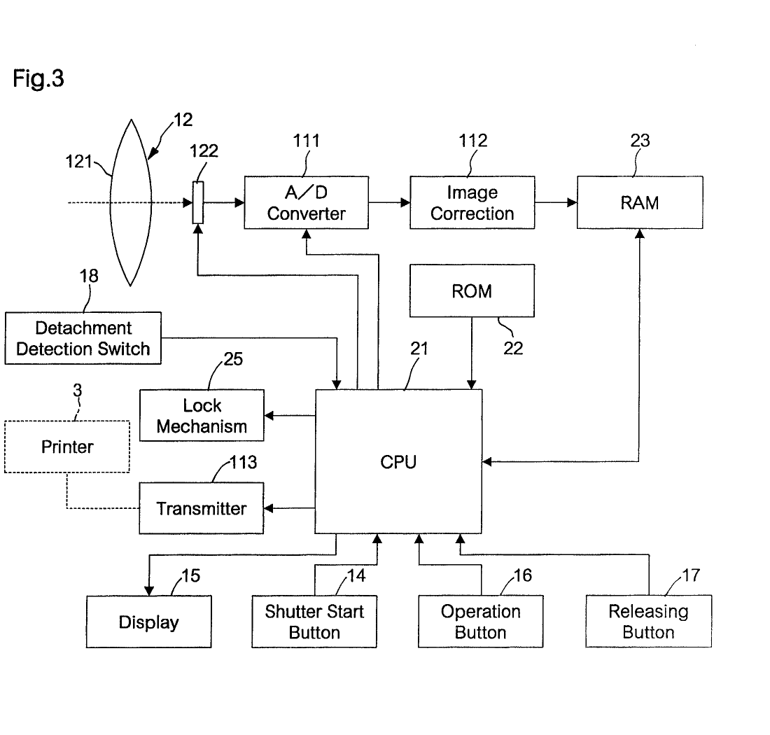

FIG. 3 is a block diagram showing in a simplified fashion the construction of the digital camera 1. The lens system 121 and the CCD 122 comprise the optical system 12, and the image of the object is obtained and stored in the RAM 23 by the optical system 12, the A/D (analog to digital) converter 111 and the image corrector 112. In other words, the image of the object is formed on the CCD 122 by the lens system 121, and when the start button 14 is pressed, the image signals from the CCD 122 are converted into digital signals by the A/D converter 111, undergo white balance and gamma correction via the image corrector 112, and are stored in the RAM 23 as image data. These processes are realized through control of the various components by the CPU 21 in accordance with the program stored in the ROM 22. While not shown, the image data in the RAM 23 can be transferred to a memory card via a card slot.

The start button 14, the display 15, the operation button 16 and the unlock button 17 shown in FIGS. 1 and 2 are connected to the CPU 21. Also connected to the CPU 21 are a transmitter 113 that sends print data to the printer 3, a locking mechanism 25 that physically locks the connection with the printer 3, and a detachment detection switch (hereinafter ‘detection switch’) 18 that detects separation from the printer 3, all of which are components pertaining to the attachment and detachment of the digital camera 1 to and from the printer 3. The operations of these components are described below.

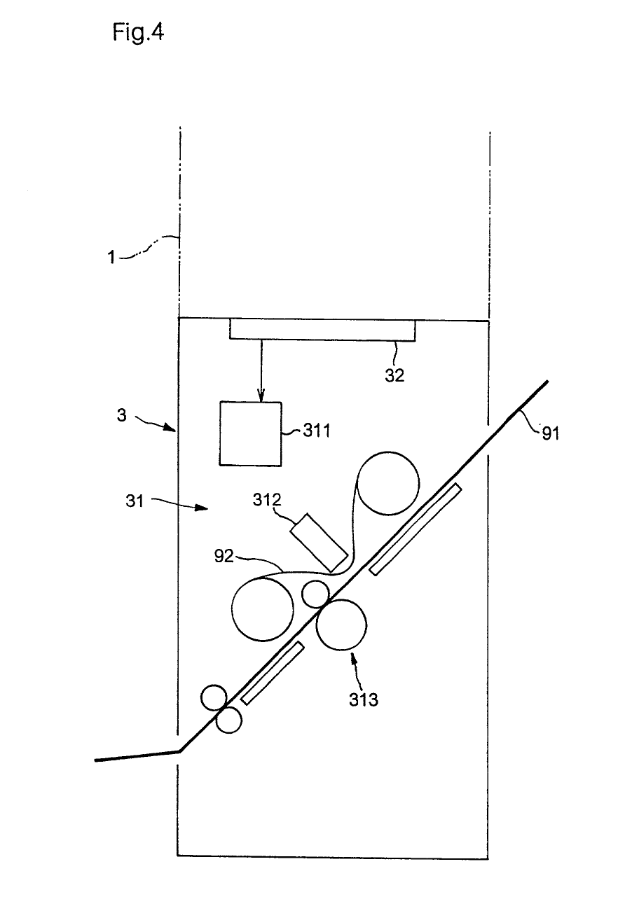

FIG. 4 is a drawing showing the main components of the printing portion 31 in the printer 3. In FIG. 4, the left side corresponds to the front surface of the printer 3. The printing portion 31 has a controller 311 that controls the printing operation, a print head 312 that performs printing onto paper 91, and a conveyance mechanism 313 that conveys the paper 91.

When the controller 311 receives print data from the digital camera 1 via the connector 32, the print head 312 is heated in accordance with the image data included in the print data. When this occurs, the conveyance mechanism 313 conveys the sheet of paper 91 as well as the ink sheet 92, and printing takes place on the sheet of paper 91 based on the sublimation of the ink in the ink sheet 92.

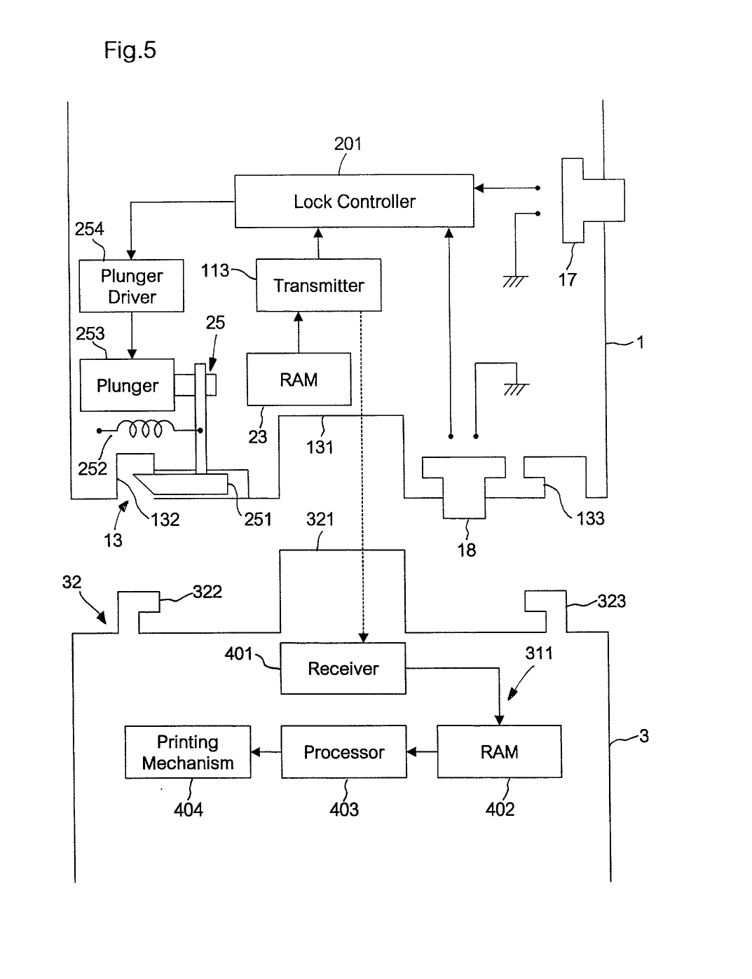

FIG. 5 is a drawing showing the connector 13 of the digital camera 1 and the connector 32 of the printer 3. In FIG. 5, the left side corresponds to the front surface of the digital camera 1. In FIG. 5, the components related to the attachment and detachment of the digital camera 1 to and from the printer 3 are shown as blocks where appropriate. Among the components shown in FIG. 5, the lock controller 201 represents the function realized by the CPU 21 or the like.

The connector 13 of the digital camera 1 has a terminal area 131 that includes multiple communication terminals, and a first engagement groove 132 and a second engagement groove 133 that are formed on the bottom of the main body 11 in the form of grooves. At the same time, the connector 32 of the printer 3 has a terminal area 321, a first hook 322 and a second hook 323 at locations that correspond to the terminal area 131, the first engagement groove 132 and the second engagement groove 133, respectively. The engagement grooves and the hooks are formed on the main body housings of the digital camera 1 and the printer 3, such that the digital camera 1 and the printer 3 are directly corrected to each other in the print system 10.

When the bottom surface of the digital camera 1 and the top surface of the printer 3 are placed together, the second hook 323 is first inserted in the second engagement groove 133, and the first hook 322 is then inserted in the first engagement groove 132. In addition, the multiple terminals of the terminal area 131 and the multiple terminals of the terminal area 321 are electrically connected, enabling communication to take place between the digital camera 1 and the printer 3.

Near the first engagement groove 132 is located a locking mechanism 25 that physically locks the connection between the digital camera 1 and the printer 3 when they are connected. The locking mechanism 25 has a lock member 251 that engages with the first hook 322, a spring 252 that provides a recovery force to the lock member 251, a plunger 253 that moves the lock member 251, and a plunger driver 254 that supplies drive power to the plunger 253.

In FIG. 5, the lock controller 201 is a component that controls the locking mechanism 25, and comprises a function realized by the CPU 21. The lock controller 201 is connected to the unlock button 17 and the detection switch 18. The detection switch 18 is located at the bottom of the digital camera 1, and enters an ON state when the digital camera 1 and the printer 3 are connected, and an OFF state when they are disconnected.

The transmitter 113 is connected to the terminals of the terminal area 131. When printing is instructed via the operation button 16 (see FIG. 3), print data including image data is supplied from the RAM 23 to the transmitter 113 via the CPU 21, and is sent from the transmitter 113 to the receiver 401 of the printer 3 via the terminal area 131 and the terminal area 321.

The receiver 401, RAM 402 and processor 403 of the printer 3 are components located inside the controller 311 shown in FIG. 4, and the printing portion 404 comprises the print head 312 and the conveyance mechanism 313. The receiver 401 receives print data via the terminal area 321, and stores it in the RAM 402. Subsequently, the processor 403 carries out processing necessary for printing such as gradation correction and CMY conversion, generates control signals and supplies them to the printing portion 404, whereby the print operation is executed.

The connection of the digital camera 1 and the printer 3 will now be explained in detail with reference to FIG. 5. When the digital camera 1 and the printer 3 are to be connected, the second hook 323 of the printer 3 is first inserted in the second engagement groove 133 of the digital camera 1. Both the second hook 323 and the second engagement groove 133 have an essentially L-shaped cross-section, and are engaged with each other to hook the printer 3 to the digital camera 1.

Subsequently, the digital camera 1 is rotated around the second engagement groove 133 so as to push the first hook 322 into the first engagement groove 132. When this is done, because the tip of the lock member 251 is slanted, the first hook 322 that comes into contact with the lock member 251 enters the first engagement groove 132 while pushing the lock member 251 aside toward the second engagement groove 133 (i.e., to the right side in FIG. 5).

At the same time, because the lock member 251 is urged toward the engagement groove 132 (i.e., to the left side in FIG. 5) by the spring 252, and the cross-section of the first hook 322 is bent toward the lock member 251 (i.e., to the right side in FIG. 5) in the form of an essentially L shape, when the first hook 322 sufficiently enters the first engagement groove 132, the lock member 251 moves to the left due to the force of the spring 252. Consequently, it becomes impossible to pull the first hook 322 out of the first engagement groove 132. In other words, the connection between the digital camera 1 and the printer 3 becomes physically locked.

When the digital camera 1 and the printer 3 are connected, the terminal area 321 and the terminal area 131 become connected, as described above, such that data or signals can be transferred between the digital camera 1 and the printer 3. When the user inputs the selection of an image for printing and a command to begin printing via operation of the operation button 16 shown in FIG. 2 while the above connection is established, the data for the selected image is read out from the RAM 23 by the CPU 21 shown in FIG. 3, and the print data including the image data is sent to the printer 3 by the transmitter 113. As a result, printing of a desired image can be executed by the printer 3.

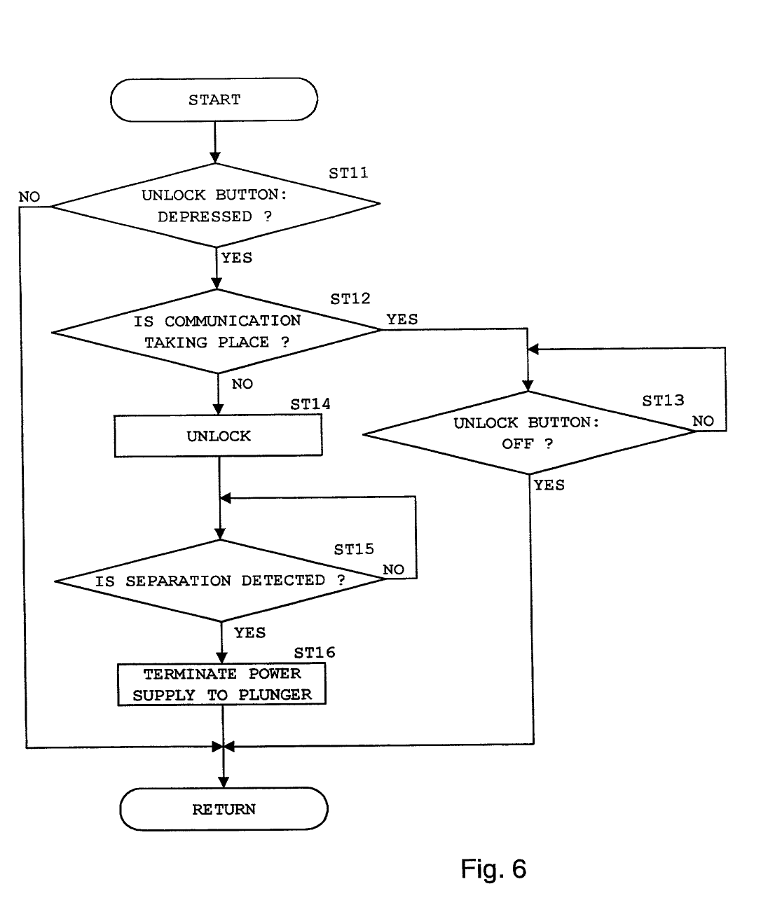

The operation of the digital camera 1 when the digital camera 1 is detached from the printer 3 via operation of the unlock button 17 will now be explained with reference to the flow chart of FIG. 6 and the components shown in FIG. 5.

When the user presses the unlock button 17, a signal indicating that the unlock button 17 has been pressed is input to the lock controller 201 (step ST111). The lock controller 201 verifies whether or not the transmitter 113 is communicating with the printer 3 (step ST12).

Where no communication is taking place with the printer 3, the lock controller 201 issues to the plunger driver 254 of the locking mechanism 25 a command to unlock. Upon receiving the command, the plunger driver 254 supplies power to the plunger 253, whereupon the plunger 253 moves the lock member 251 out of the first engagement groove 132 against the force of the spring 252. As a result, the lock state maintained by the lock member 251 and the first hook 322 is ended (step ST14).

When the lock state is ended, the digital camera 1 and the printer 3 become separated through the separation of the first hook 322 from the first engagement groove 132 and of the second hook 323 from the second engagement groove 133. When this occurs, pressure is no longer applied to the detection switch 18 of the digital camera 1 by the top surface of the printer 3, and as a result the detection switch 18 detects the separation of the digital camera 1 from the printer 3 (step ST15). The detection signal is input to the lock controller 201. Upon receiving the signal from the detection switch 18, the lock controller 201 sends a signal to the plunger driver 254, which terminates the power supply to the plunger 253 (step ST16). Subsequently, the lock controller 201 returns to its state prior to the pressing of the unlock button 17.

On the other hand, where the digital camera 1 is engaged in communication with the printer 3 when the unlock button 17 is pressed, the input issued by the unlock button 17 instructing that the lock state be ended is deemed invalid by the lock controller 201, which waits to confirm that the unlock button has entered the OFF state (step ST13) and returns to the original state. That is, the lock controller 201 ignores the operation of the unlock button 17. Therefore, the lock state regarding the connection between the digital camera 1 and the printer 3 is maintained, preventing the separation of the digital camera 1 from the printer 3.

As a result, the problem of the user mistakenly detaching the digital camera 1 from the printer 3 while they are still engaged in communication is prevented. Incidentally, in the above discussion, the term ‘communication’ between the digital camera 1 and the printer 3 refers to the series of communication processes that are necessary to perform printing, i.e., printing-related communication, and comprises, for example, the series of communication processes that begins when the signal to begin communication is sent from the digital camera 1 and ends when a signal to end the communication is sent.

Therefore, where the printer 3 has a sufficient memory capacity and the transfer of print data can be completed before printing begins, it is possible to separate the digital camera 1 from the printer 3 before the printing operation starts. On the other hand, in the case of a printer that does not have a sufficient memory capacity, such as a so-called line printer (or a printer to which the print data is transferred serially, for example), separation of the digital camera 1 from the printer 3 is prohibited until the printing is virtually completed.

Furthermore, so long as printing is not hindered, it is acceptable if the digital camera 1 can be detached from the printer 3 while communication between the two is still underway (i.e., while they are engaged in communication for a purpose other than printing). Naturally, separation may be prohibited during any type of communication (i.e., any communication other than printing-related communication).

Moreover, separation of the digital camera 1 from the printer 3 may also be prohibited for safety reasons for a certain period of time following the completion of communication. For example, the connection may be kept locked until the printer 3 is finished printing. Maintaining the locked connection at least while the digital camera 1 and the printer 3 are engaged in printing-related communication in this way enables printing errors caused by a severed communication link to be prevented.

<2. Second Embodiment>

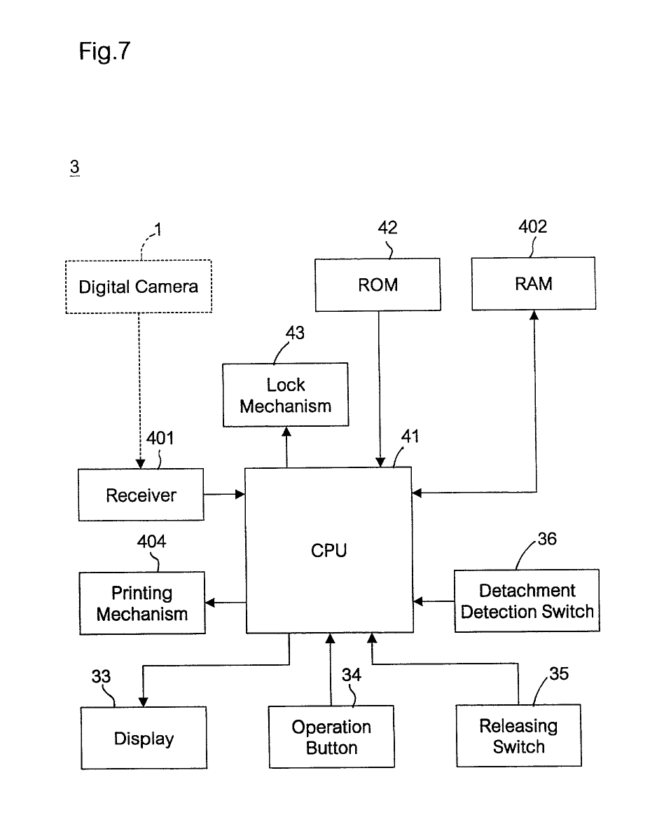

In the first embodiment, the digital camera 1 includes a locking mechanism 25 and a lock controller 201, but these components may be included in the printer 3 instead. FIG. 7 is a drawing showing the construction of the printer 3 when a locking mechanism 43, a lock controller (a function realized by the CPU 41 or the like), an unlock button 35 and a detection switch 36 are included in the printer 3. The remainder of the construction is identical to that of the printer 3 of the first embodiment, and the same numerals are used where appropriate. In other words, the construction shown in FIG. 7 without the locking mechanism 43, the unlock button 35 and the detection switch 36 is equivalent to the construction of the printer 3 of the first embodiment as a practical matter.

Conversely, the digital camera 1 of this embodiment has the construction shown in FIG. 3 without the locking mechanism 25, the unlock button 17 and the detection switch 18. The same numerals are used in the description below for the same components as those included in the digital camera 1 and the printer 3 of the first embodiment.

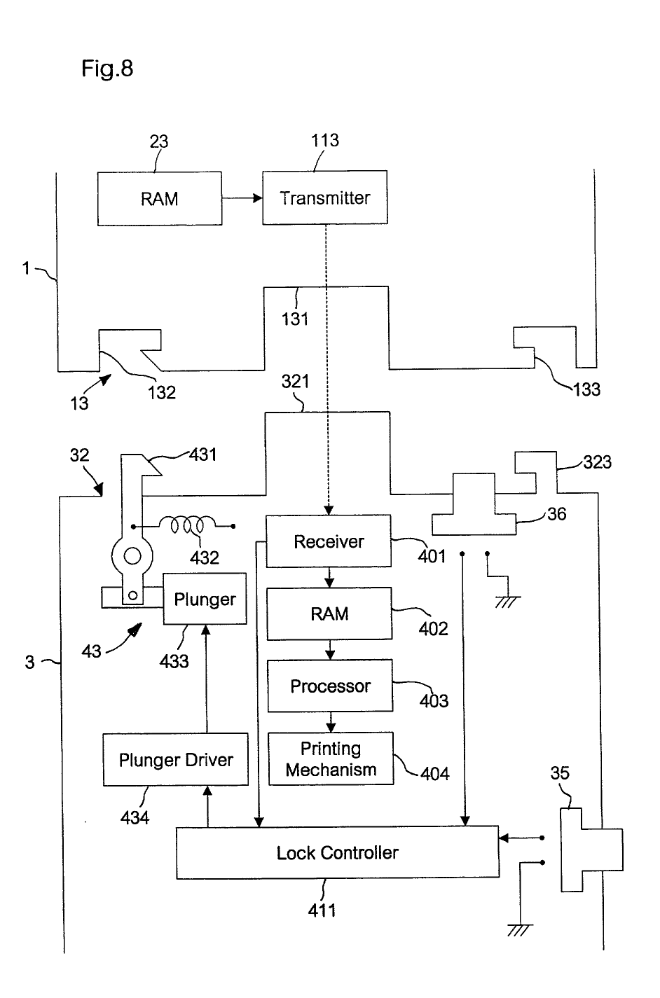

FIG. 8 is a drawing showing the connector 13 of the digital camera 1 and the connector 32 of the printer 3, and shows the components using blocks as in FIG. 5. Among the components shown in FIG. 8, the lock controller 411 and the processor 403 are functions realized by the CPU 41, shown in FIG. 7, operating in accordance with the program stored in the ROM 42.

The connector 13 of the digital camera 1 has a terminal area 131, a first engagement groove 132 and a second engagement groove 133, and the terminal area 131 and the second engagement groove 133 are identical to those of the first embodiment. The first engagement groove 132 has an essentially L-shaped cross-section. The connector 32 of the printer 3 has a terminal area 321 and a second hook 323, which are identical to those of the first embodiment, but instead of a first hook, the lock member 431 of the locking mechanism 43 is located inside the printer 3 such that it protrudes from the top surface thereof. The terminal area 321, the lock member 431 and the second hook 323 of the printer 3 are located at locations that correspond to the terminal area 131, the first engagement groove 132 and the second engagement groove 133 of the digital camera 1, respectively.

The locking mechanism 43 has a lock member 431, a spring 432, a plunger 433 and a plunger driver 434 as in the first embodiment. The part of the lock member 431 that protrudes upward and the cross-section of the first engagement groove 132 both have an essentially L-shaped configuration (bent to the right side), and the protruding part of the lock member 431 is urged to the right side in FIG. 8 by the spring 432.

The unlock button 35 is located on the rear surface of the printer 3, and the detection switch 36 is located on the top surface. These are electrically connected to the lock controller 411.

When the digital camera 1 and the printer 3 are to be connected, the user first assembles the second hook 323 and the second engagement groove 133, as in the first embodiment, places together the lock member 431 and the first engagement groove 132, and pushes the former component into the latter component. The top end of the lock member 431 enters the first engagement groove 132 while moving toward the left of the drawing along the contours of the first engagement groove 132, and once it has progressed to a certain position, it moves to the right side due to the urging force of the spring 432.

Consequently, the top end of the lock member 431 and the first engagement groove 132 become engaged with each other, whereby the connection between the digital camera 1 and the printer 3 becomes physically locked. In addition, the terminal area 321 and the terminal area 131 become connected, enabling communication to occur between the digital camera 1 and the printer 3.

Subsequently, as in the first embodiment, through user operation of the operation button 16 (see FIG. 2) of the digital camera 1, the print data stored in the RAM 23 is sent from the transmitter 113 to the receiver 401 of the printer 3 via the terminal areas 131 and 321, and is stored in the RAM 402. In the printer 3, the processor 403 generates control signals from the print data stored in the RAM 402, and printing is executed by the printing portion 404.

The operation of the printer 3 when printing is completed and the two apparatuses are to be separated via the operation of the unlock button 35 on the rear surface of the printer 3 is identical to the operation shown in FIG. 6. That is, when the unlock button 35 is pressed by the user, the lock controller 411 verifies whether or not the receiver 401 is communicating with the digital camera 1 (steps ST111 and ST12). Where no communication is taking place with the digital camera 1, the lock controller 411 issues an unlock command to the plunger driver 434, and the plunger 433 receives power. Consequently, the plunger 433 moves the top end of the lock member 431 against the force of the spring 432, and the lock state maintained by the lock member 431 and the first engagement groove 132 is terminated (step ST13).

When the lock state is ended and the digital camera 1 and the printer 3 become separated, the detection switch 36 on the top surface of the printer 3 becomes OFF and detects the separation (step ST14). The lock controller 411 terminates the power supply to the plunger 433 via the plunger driver 434 (step ST15), and returns to its state prior to the pressing of the unlock button 35.

On the other hand, where the digital camera 1 is engaged in communication with the printer 3 when the unlock button 35 is pressed, the input issued by the unlock button 35 instructing that the lock state be ended is deemed invalid by the lock controller 411, which returns to its original state without performing any processing (step ST12). That is, the lock controller 411 ignores the operation of the unlock button 35. Therefore, the lock state regarding the connection between the digital camera 1 and the printer 3 is maintained, preventing the separation of the digital camera 1 from the printer 3.

As a result, as in the first embodiment, the problem of the user mistakenly detaching the digital camera 1 from the printer 3 while they are still engaged in communication is prevented, whereby printing errors due to communication failures are also prevented.

<3. Modification>

Explanations were provided above regarding embodiments of the present invention, but the implementation of the present invention is not limited to these embodiments. The present invention may be implemented through various modifications as well.

In the embodiments described above, either the digital camera 1 or the printer 3 has the lock controller, the locking mechanism, the unlock button and the detection switch, but these components may be included both in the digital cameras 1 and the printer 3. For example, only one of the lock controller, the locking mechanism and the unlock button may be included in the digital camera 1 while the other components are included in the printer 3. Conversely, only one of the components may be included in the printer 3 while the other components are included in the digital camera 1.

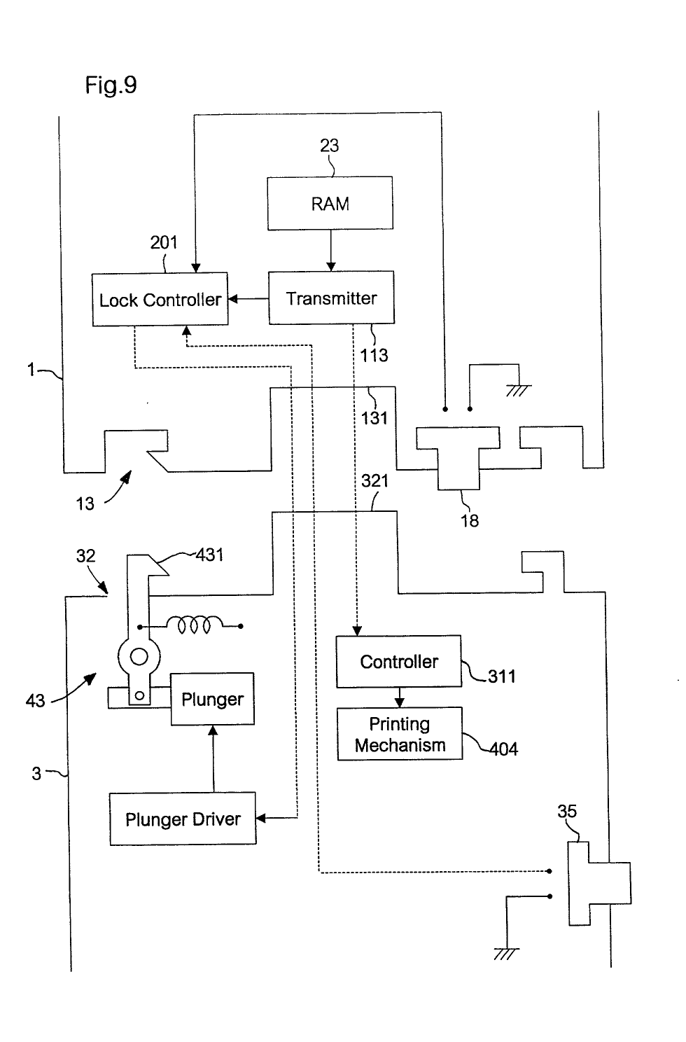

FIG. 9 is a drawing showing an example in which the lock controller 201 and the detection switch 18 are included in the digital camera 1 and the locking mechanism 43 and the unlock button 35 are included in the printer 3. Other components are identical to those in the above embodiments, and are assigned the same numerals. In this case, the lock controller 201 controls the locking mechanism 43 via the terminal areas 131 and 321, and the signal from the unlock button 35 is also input to the lock controller 201 via the terminal areas 131 and 321.

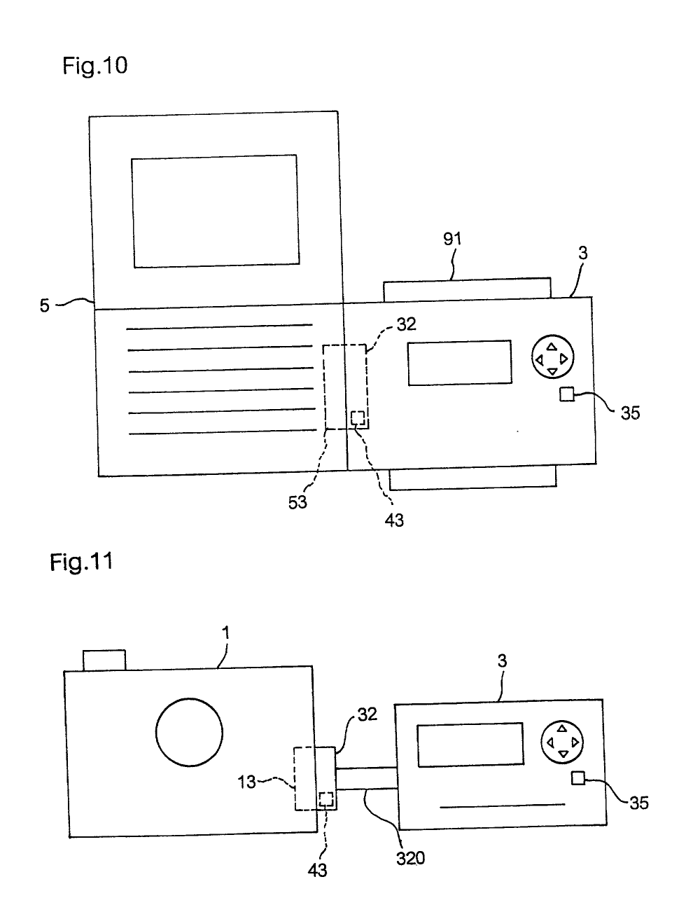

Furthermore, in the above embodiments, a digital camera is connected to the printer, but the apparatus connected to the printer is not limited to a digital camera. Any data supplier that sends print data to the printer may be connected thereto. For example, the print system may comprise a computer 5 and a printer 3, as shown in FIG. 10. In other words, the connector 53 of the computer 5 and the connector 32 of the printer 3 are connected, and a locking mechanism 43 is included in the connector 32. In addition, the operation of the unlock button 35 of the printer 3 is deemed invalid while the computer 5 is communicating with the printer 3.

Each of the above embodiments comprises a print system 10 that incorporates a digital camera 1 and a printer 3 that are connected using a connector 13 located in the main body housing of the digital camera 1 and a connector 32 located in the main body housing of the printer 3, but the connection of the two apparatuses is not limited to a form in which the housings of each apparatus are interconnected. In other words, so long as the connection ensures an electrical connection between the apparatuses while they are communicating for printing, other forms of connection may be adopted.

For example, as shown in FIG. 11, the connector 32 of the printer 3 may be connected to the printer main body via a cable 320, and the connector 13 of the digital camera 1 and the connector 32 of the printer 3 may be connected. In this case, the locking mechanism 43 is included in the connector 32, and when the unlock button 35 of the printer 3 is operated, the lock created by the locking mechanism 43 is ended in principle. While the apparatuses are communicating, even if the unlock button 35 is operated, such operation is deemed invalid by the lock controller of the printer 3. Therefore, the connector 32, which comprises the end of the cable 320, is physically prohibited from being detached from the digital camera 1 while communication is underway.

In addition, any device may be used for the locking mechanism so long as it comprises a mechanism that physically locks the digital camera 1 and the printer 3 together.

In the above embodiments, the unlock button is physically included in the digital camera 1 or the printer 3, but the construction may be such that a function equivalent to the unlock button is realized via a method in which the unlock operation may be selected using the operation button 16 or 34 in accordance with a menu displayed on the display 15 or 33. Here, the elimination of a dedicated unlock button enables the cost of manufacture to be reduced.

In the above embodiments, explanations were supplied using a dye-sublimation thermal transfer printer 3, but the present invention may be applied in printers using other methods, such as the inkjet method or other thermal transfer method.

Furthermore, the lock controller may be realized in whole or in part as a dedicated electric circuit instead of by the CPU operating in accordance with a program.

Using any of the constructions described above, because the lock is maintained by the lock mechanism at least while communication regarding printing is being carried out between the data supplier and the printer, printing errors caused by erroneous detachment of the data supplier from the printer during communication may be prevented.

Moreover, because the input that instructs that the lock state be ended is deemed invalid by the lock controller, printing errors caused by erroneous detachment of the data supplier from the printer while communication therebetween is underway may be prevented.

Moreover, using any of the above constructions, because the lock secured by the lock mechanism is maintained at least while communication regarding printing is being carried out between the transmitter and the printing portion, printing errors caused by erroneous detachment of the transmitter from the printing portion during communication may be prevented.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A data supplier that transmits print data, said supplier comprising:
a connector that can be connected to a printer;
a transmitter that sends print data to the printer via the connector;
a lock mechanism that physically locks the connection established using the connector; and
a lock controller that maintains the lock secured by the lock mechanism at least while communication regarding printing is being carried out with the printer.

2. The data supplier according to claim 1, wherein said lock controller deems invalid any input that instructs that the lock state be ended so long as communication regarding printing is underway with the printer.

3. The data supplier according to claim 1, wherein said data supplier comprises a digital camera.

4. The data supplier according to claim 1, wherein said data supplier comprises a computer.

5. The data supplier according to claim 1, wherein said connector is connected while the housing of the data supplier and the housing of the printer are in mutual contact.

6. A printer comprising:
a connector that can be connected to a data supplier that sends print data;
a printing portion that performs printing based on print data sent from the data supplier via the connector;
a lock mechanism that physically locks the connection established using the connector; and
a lock controller that maintains the lock secured by the lock mechanism at least while communication regarding printing is being carried out with the data supplier.

7. The printer according to claim 6, where said lock controller deems invalid any input that instructs that the lock state be ended so long as communication regarding printing is underway with the data supplier.

8. The printer according to claim 6, wherein said connector is connected to a digital camera as the data supplier.

9. The printer according to claim 6, wherein said connector is connected to a computer as the data supplier.

10. The printer according to claim 1, wherein said connector is connected while the housing of the data supplier and the housing of the printer are in mutual contact.

11. The printer according to claim 6, wherein said connector includes a cable.

12. A print system comprising:
a printing portion that performs printing based on print data;
a transmitter that can be connected to or separated from the printing portion and that sends print data to the printing portion while being connected thereto;
a lock mechanism that physically locks the connection established between the printing portion and the transmitter; and
a lock controller that maintains the lock secured by the lock mechanism at least while communication regarding printing is being carried out between the printing portion and the transmitter.

13. The print system according to claim 12, wherein said lock controller deems invalid any input that instructs that the lock state be ended so long as communication regarding printing is underway between the printing portion and the transmitter.

14. The print system according to claim 12, wherein said transmitter comprises a digital camera.

15. The print system according to claim 12, wherein said transmitter comprises a computer.
